(19) United States
(12) Patent Application Publication
(10) Pub. No.: US 2025/0360493 A1
(43) Pub. Date: Nov. 27, 2025

(54) TIO2-CQDS NANOFLOWER PHOTOCATALYST, PHOTOCATALYTIC THIN FILM AND APPLICATION

(71) Applicant: Hefei University of Technology, Hefei (CN)

(72) Inventors: Kezhou CAI, Hefei (CN); Jingnan LU, Hefei (CN); Manzi HU, Hefei (CN); Zhihao GONG, Hefei (CN); Hebao MEI, Hefei (CN); Kai ZHOU, Hefei (CN); Hui ZHOU, Hefei (CN); Baocai XU, Hefei (CN)

(21) Appl. No.: 18/911,112

(22) Filed: Oct. 9, 2024

(30) Foreign Application Priority Data
May 24, 2024 (CN) 2024106567230

(51) Int. Cl. B01J 21/18; A23L 5/20; A62D 3/176; A62D 3/38; A62D 101/20; B01J 21/06; B01J 35/39; B01J 35/45; B01J 37/04; B01J 37/08; B01J 37/34; B82Y 30/00; B82Y 40/00; C01B 32/15

(52) U.S. Cl. CPC B01J 21/18; A23L 5/276; A62D 3/176; A62D 3/38; B01J 21/063; B01J 35/39; B01J 35/45; B01J 37/04; B01J 37/08; B01J 37/346; C01B 32/15; A62D 2101/20; B82Y 30/00; B82Y 40/00

(57) ABSTRACT

The disclosure provides a TiO₂-CQDs nanoflower photocatalyst, a photocatalytic thin film and an application, belonging to a technical field of photocatalyst for food processing. The TiO₂-CQDs nanoflower photocatalyst includes TiO₂ and CQDs doped with TiO₂. the CQDs is derived from aloe extract. According to the disclosure, the extract obtained from natural aloe is used as a carbon source to provide CQDs, and TiO₂ is modified to obtain the nanoflower photocatalyst and the photocatalytic thin film for catalytic degradation of polycyclic aromatic hydrocarbons (PAHs).

### TECHNICAL FIELD

The disclosure belongs to a technical field of photocatalyst for food processing, and in particular to a TiO₂-CQDs nanoflower photocatalyst, a photocatalytic thin film and an application.

### BACKGROUND

Polycyclic aromatic hydrocarbons (PAHs) are hydrocarbons containing two or more benzene rings, characterized by a stable chemical structure and by being difficult to degrade. PAHs are widely found in food, air, and other human environments and are formed primarily from the incomplete combustion of organic materials such as oil, wood, and tobacco. Accumulation of PAHs in the human body damages the respiratory system, liver and other organs, even causing reproductive disorders. As a result, many countries around the world have strict regulations on PAHs, and the National Environmental Protection Agency (EPA) of the United States has identified 16 PAHs as priority pollutants. The most toxic of the PAHs is Benzo[a]pyrene (B(a)P). As the first known environmental chemical carcinogen, B(a)P is considered an indicator of PAH pollution in the environment. B(a)P can enter the human body through inhalation, esophagus, skin absorption, etc. It has been classified as a Class I carcinogen based on population studies and epidemiological studies, and is known to cause mainly skin, lung, digestive tract, and bladder cancer. Smoked food has a unique smoky flavor and aroma, which attracts consumers' love. Especially smoked meat products, such as smoked sausage, bacon, smoked ham, etc. However, PAHs are enriched in foods during the smoking process. Considering that 80% of B(a)P in the human body comes from food, countries all over the world have imposed strict regulations regarding B(a)P content in smoked foods. China's food hygiene standard (GB7104-94) stipulates that the content of B(a)P in smoked food should not exceed 5 μg/kg. Therefore, the identification and reduction of B(a)P in food is of great importance for human public health.

Photocatalytic oxidation has gradually become a sustainable technology for degrading chemical pollutants. In this process, the suitable photocatalyst should meet the characteristics of high efficiency, non-toxicity and recyclability. Titanium dioxide (TiO₂) has been widely used in photocatalytic reactions in water and other fields as an environmentally friendly photocatalyst due to its good photocatalytic activity and non-toxicity. Anatase, rutile and brookite are the three crystal structures of TiO₂ found in nature. Among the three crystal structures, rutile has the best thermal stability, and the titanium oxide octahedron in anatase unit cell structure has a higher degree of distortion and the most significant photocatalytic activity. At present, it is found that the catalytic performance of anatase/rutile mixed-phase is higher than that of single component catalyst. However, TiO₂ has a high band gap value, and the hole potential of TiO₂ cannot be excited under natural light. At the same time, the recombination rate of electrons and holes is faster, which reduces the quantum efficiency of light, thus weakening the catalytic activity and hindering the effective utilization of TiO₂. At present, the research mainly focuses on inducing oxygen vacancy defects on the surface of TiO₂ by doping or depositing noble metals and semiconductor materials, enhancing the quantum efficiency of light, reducing the recombination of photo-generated carriers and improving the application characteristics of photocatalyst. However, commercial metal oxides are expensive and not very safe.

In the disclosure, carbon dots (CQDs) are synthesized from natural extracts, and mixed-phase TiO₂ (anatase/rutile) is modified by CQDs to prepare TiO₂-CQDs nanoflowers, forming a TiO₂-CQDs nanocomposite material with excellent performance and potential application perspective, the disclosure is specifically applied to control polycyclic aromatic hydrocarbons in smoked food and environment.

### SUMMARY

As a widely cultivated and used plant, aloe contains a variety of active substances and can be easily modified. As a natural and inexpensive carbon source, aloe extract has the potential to produce CQDs. For photocatalysis, the reaction surface area is extremely important, and the larger the surface area, the more active sites are available to increase the possibility of reaction. This goal can be effectively achieved by using low-dimensional materials, particularly two-dimensional nanomaterials. However, it is still challenging to construct a photocatalytic system with appropriate geometry based on two-dimensional materials. The present disclosure utilizes aloe extract as a carbon source to synthesize CQDs, and the prepared CQDs are subsequently employed to modify TiO₂, resulting in the fabrication of TiO₂-CQDs nanoflowers. The present disclosure employs the natural plant extract as a carbon source to modify efficiently TiO₂, preparing a TiO₂-CQDs nanoflower photocatalyst with superior performance in the degradation of polycyclic aromatic hydrocarbons.

A TiO₂-CQDs nanoflower photocatalyst is provided in the first aspect of the disclosure, including TiO₂ and CQDs doped with TiO₂. the CQDs is derived from aloe extract. Specifically, CQDs is attached to the surface of nanoflowers by physical doping.

In certain practical instances, the crystal structure of TiO₂ is selected from one of anatase, rutile and brookite, or a mixed phase of any two crystal forms, or a mixed phase of three crystal forms. Optionally, the crystal structure of TiO₂ is anatase/rutile mixed phase (A/R-TiO₂). Specifically, the lattice fringe spacing is an important index in substances that react the morphological characteristics of catalytic materials. The lattice fringe of each photocatalytic material is clearly displayed. After Energy-Filtered Transmission Electron Microscopy (EFTEM) test, a lattice fringe spacing of 0.352 nm is observed in the TiO₂-CQDs, and is in correspondence with a plane (101) of anatase-TiO₂. a characteristic lattice fringe spacing of 0.321 nm is observed in the TiO₂-CQDs, aligning with a plane (110) of rutile-TiO₂, while a spacing of 0.263 nm is attributed to a plane (100) of the CQDs.

In certain practical instances, in terms of the total mass of the TiO₂-CQDs nanoflower photocatalyst, a mass content of CQDs in the TiO₂-CQDs nanoflower photocatalyst is 10-50 wt %, with specific ranges including 10-20 wt %, 20-30 wt %, 30-40 wt %, or 40-50 wt %.

In certain practical instances, a particle size of CQDs in the TiO₂-CQDs nanoflower photocatalyst is 1.5-2.5 nm, with specific ranges including 1.5-1.8 nm, 1.8-2.2 nm or 1.5-2.5 nm.

In certain practical instances, an ultraviolet absorption band of the TiO₂-CQDs nanoflower photocatalyst is 200-420 nm. Experimental findings reveal that in comparison to TiO₂ exhibiting a broad absorption band under ultraviolet light with wavelengths ranging from 200 to 400 nm, the absorption of TiO₂-CQDs is shifted towards the higher frequency region. This indicates that the incorporation of CQDs enhances the absorption of ultraviolet light, resulting in a redshift of the TiO₂ absorption peak.

In certain practical instances, an energy band gap (Eg) of the TiO₂-CQDs nanoflower photocatalyst is 2.8-3.1 eV, and Eg is calculated by determining the intercept of the tangent line on the curve in the photon energy versus wavelength plot. Eg refers to the minimum energy required for electrons to transition from the valence band to the conduction band in the photocatalyst material, and is an important parameter for evaluating the light absorption and photocatalytic activity of the photocatalyst. The results indicate a reduction in the Eg of TiO₂ to 3.24 CV with the addition of CQDs, indicating a introduction of a new energy state at the molecular orbital interface of TiO₂-CQDs in some cases.

In certain practical instances, a degradation rate of the TiO₂-CQDs nanoflower photocatalyst is 0.1-0.2 min⁻¹, with specific ranges including 0.1-0.15 min⁻¹or 0.15-0.2 min⁻¹.

A preparation method of the TiO₂-CQDs nanoflower photocatalyst is provided in the second aspect of the disclosure with steps as follows:

1) Providing TiO₂ nanoflowers.

Specifically, Pluronic(R)F-127, acetic acid and hydrogen chloride (HCl) are dissolved in tetrahydrofuran, tetrabutyl titanate is added under stirring, dissolved in alcohol solvent after aging, and glycerol is added, and after reflux reaction for 6-24 h, TiO₂ nanoflowers are obtained through cleaning, drying and sintering.

Specifically, the volume ratio of Pluronic(R)F-127, tetrahydrofuran, acetic acid, HCl and tetrabutyl titanate is 5-6:60-80:5-8:6-10:1-5. more specifically, a dosage of tetrahydrofuran is 60-80 mL, a dosage of Pluronic(R)F-127 is 5-6 g, a dosage of glacial acetic acid (>99%) is 5-8 mL, and a dosage of HCl (38%) is 6-10 mL. 1-5 mL tetrabutyl titanate is added dropwise under continuous stirring (200-500 r/min), and then aged at 50° C. for 6-8 h.

Specifically, the ratio of the aged colloidal substance mass, the alcohol solvent volume and the glycerol volume is 1-5:10-40:5-15; more specifically, the aged colloidal substance (1-5 g) is dissolved in 10-40 mL ethanol, then 5-15 mL glycerol is added and refluxed at 100-120° C. for 10-15 h. The precipitate after ethanol cleaning is dried at 70-90° C., and then sintered at 550° C. to obtain A/R-TiO₂ nanoflowers.

2) Performing microwave reaction on the aqueous solution or aqueous suspension of the purchased aloe extract, and performing post-treatment to obtain CQDs.

Specifically: 2-1) The conditions of microwave reaction are as follows: irradiating the aqueous solution or suspension of aloe for 10-60 min under the microwave condition of 400-800 W. alternatively, the microwave conditions may be 400-500 W, 500-600 W, 600-700 W or 700-800 W;

2-2) The post-treatment involves centrifugation to obtain the CQDs precursor, followed by drying the CQDs precursor at a temperature between 70-90° C. to obtain the CQDs. The drying temperature may be within the range of 70-80° C. or 80-90° C. The drying time may be specifically selected as needed, typically ranging from 1-10 h.

3) Mixing the solution or suspension containing TiO₂ nanoflowers with the solution or suspension containing CQDs, stirring at 100-500 r/min for 1-5 h, and drying and sintering to obtain the TiO₂-CQDs nanoflower photocatalyst.

Specifically, in terms of the total mass of the TiO₂-CQDs nanoflower photocatalyst, the mass content of CQDs in the TiO₂-CQDs nanoflower photocatalyst is 10-50 wt %, with specific ranges including 10-20 wt %, 20-30 wt %, 30-40 wt %, or 40-50 wt %. More specifically, the drying temperature is 80-100° C., optionally 80-90° C. or 90-100° C. more specifically, the drying is performed under a vacuum condition.

more specifically, the sintering temperature is 500-650° C., with specific ranges including 500-550° C., 550-600° C. or 600-650° C.

A photocatalytic thin film is provided in the third aspect of the disclosure, the photocatalytic thin film contains the TiO₂-CQDs nanoflower photocatalyst provided in the first aspect or the TiO₂-CQDs nanoflower photocatalyst prepared by the preparation method provided in the second aspect.

In certain practical instances, in terms of solvent mass, the content of TiO₂-CQDs nanoflower photocatalyst is 0.1-5 wt %, and the content can be 0.1-1wt %, 1-2 wt %, 2-3 wt %, 3-4 wt % or 4-5 wt %.

In certain practical instances, the photocatalytic thin film further includes a film material selected from sodium alginate or water-soluble polymer. For example, the TiO₂-CQDs nanoflower photocatalyst is added to the aqueous solution of sodium alginate or water-soluble polymer, and cured to form a film.

In certain practical instances, the photocatalytic thin film further includes a plasticizer, optionally glutaraldehyde, and the content of the plasticizer is 10-30 wt % in terms of the total mass of the photocatalytic thin film.

The photocatalytic thin film is wrapped on the surface of smoked food for ultraviolet irradiation when in use. Owing to the photocatalyst's exceptional photocatalytic degradation capabilities, the presence of PAHs on the surface of smoked food is significantly diminished under ultraviolet irradiation. The photocatalytic thin film is capable of being applied to smoke emission process for reducing PAHs emission in particulate matter.

An application of the TiO₂-CQDs nanoflower photocatalyst provided in the first aspect, or the TiO₂-CQDs nanoflower photocatalyst prepared by the preparation method provided in the second aspect, or the photocatalytic film provided in the third aspect in controlling PAHs is provided in the fourth aspect of the disclosure.

In an optional instance, an application in controlling PAHs in smoked food is provided. optionally, an application in controlling PAHs in smoked environment is provided. Specifically, smoked foods include but are not limited to sausages, bacon, smoked fish, etc. A healthy eating environment is provided according to the disclosure. the disclosure collects particles in the environment, thereby effectively reducing PAHs in the environment and providing a healthy atmospheric environment. More optionally, the PAHs are (B(a)P).

The TiO₂-CQDs nanoflower photocatalyst, the preparation method thereof and the photocatalytic film provided by the disclosure have at least the following beneficial technical effects:

First, the TiO₂-CQDs nanoflower photocatalyst and the photocatalytic thin film of the disclosure have excellent catalytic degradation ability of PAHs.

Second, according to the disclosure, natural aloe extract is innovatively used as a carbon source to provide CQDs, and TiO₂ is modified, and finally the nanoflower photocatalyst and the catalytic film with excellent catalytic degradation ability of polycyclic aromatic hydrocarbons are obtained. Specifically, the ultraviolet combined with photocatalyst is capable of significantly degrading B(a)P, and the photocatalytic thin film can significantly reduce the B(a)P of smoked sausage.

Third, photocatalytic thin film can be applied to reduce B(a)P in particulate matter discharged into the atmosphere during the smoking process.

### BRIEF DESCRIPTION OF THE DRAWINGS

FIG. 1 is a schematic diagram showing a preparation route of TiO₂-CQDs nanoflower photocatalyst in Embodiment 1 of the present disclosure.

FIG. 2A is a TiO₂-CQDs Energy-Filtered Transmission Electron Microscopy (EFTEM) image in Embodiment 1 of the present disclosure.

FIG. 2B is a partial enlarged view 1 of the TiO₂-CQDs EFTEM image in Embodiment 1 of the present disclosure.

FIG. 2C is a partial enlarged view 2 of the TiO₂-CQDs EFTEM image in Embodiment 1 of the present disclosure.

FIG. 2D is a TiO₂-CQDs EFTEM lattice energy image in Embodiment 1 of the present disclosure.

FIG. 2E is an EFTEM image of CQDs in Embodiment 1 of the present disclosure.

FIG. 2F is an element spectrum of Ti in Embodiment 1 of the present disclosure.

FIG. 2G is an element spectrum of O in Embodiment 1 of the present disclosure.

FIG. 2H is an element spectrum of C in Embodiment 1 of the present disclosure.

FIG. 2I is an element spectrum of N in Embodiment 1 of the present disclosure.

FIG. 2J is an Energy Dispersive X-Ray Spectroscopy (EDX) diagram of elements in Embodiment 1 of the present disclosure.

FIG. 3A is an X-Ray Diffraction (XRD) spectrum of TiO₂-CQDs and TiO₂ in Embodiment 1 of the present disclosure.

FIG. 3B is an X-ray photoelectron spectroscopy (XPS) survey spectrum of TiO₂-CQDs and TiO₂ in Embodiment 1 of the present disclosure.

FIG. 3C is a Carbon 1s (C1s) spectrogram of TiO₂-CQDs and TiO₂ in Embodiment 1 of the present disclosure.

FIG. 3D is a Titanium 2p (Ti2p) spectrogram of TiO₂-CQDs and TiO₂ in Embodiment 1 of the present disclosure.

FIG. 3E is an Oxygen 1s (O1s) spectrogram of TiO₂-CQDs and TiO₂ in Embodiment 1 of the present disclosure.

FIG. 3F is a Nitrogen 1s (N1s) spectrogram of TiO₂-CQDs and TiO₂ in Embodiment 1 of the present disclosure.

FIG. 3G is a Fourier Transform Infrared Spectroscopy (FTIR) related to TiO₂-CQDs and TiO₂ in Embodiment 1 of the present disclosure.

FIG. 4A is an Ultraviolet-Visible Diffuse Reflectance Spectroscopy (UV-Vis) related to TiO₂-CQDs and TiO₂ in Embodiment 1 of the present disclosure.

FIG. 4B is a an energy band gap diagram related to TiO₂-CQDs and TiO₂ in Embodiment 1 of the present disclosure.

FIG. 4C is a Photoluminescence (PL) spectrogram related to TiO₂-CQDs and TiO₂ in Embodiment 1 of the present disclosure.

FIG. 4D is a thermogravimetric analysis diagram of TiO₂-CQDs in Embodiment 1 of the present disclosure.

FIG. 4E is a thermogravimetric analysis diagram of TiO₂ in Embodiment 1 of the present disclosure.

FIG. 5A is an electron paramagnetic resonance (EPR) spectrum of oxygen vacancy in Embodiment 1 of the present disclosure.

FIG. 5B is an EPR spectrum of DMPO-·OH in Embodiment 1 of the present disclosure.

FIG. 5C is an EPR spectrum of DMPO-·O₂⁻ in Embodiment 1 of the present disclosure.

FIG. 5D is an EPR spectrum of TE; MPO-h+ in Embodiment 1 of the present disclosure.

FIG. 5E is an impedance test diagram of photocatalyst in Embodiment 1 of the present disclosure.

FIG. 5F is a current intensity test diagram of the photocatalyst Embodiment 1 of the present disclosure.

FIG. 6A is an application test diagram of photocatalytic degradation of B(a)P.

FIG. 6B shows an application linear first-order model of the photocatalytic degradation of B(a)P.

FIG. 6C is a photocatalytic degradation diagram of B(a)P with a free radical scavenger.

FIG. 6D is a linear first-order model of the photocatalytic degradation of B(a)P with the free radical scavenger.

FIG. 6E shows a contribution of active ingredients to the degradation of B(a)P.

FIG. 6F shows a reusability test on the photocatalyst.

FIG. 7A shows Langmuir and Freundlich adsorption curves of Embodiment 2.

FIG. 7B shows pseudo first-order dynamics of Embodiment 2.

FIG. 7C shows pseudo second-order dynamics of Embodiment 2.

FIG. 7D shows an intra-particle diffusion of Embodiment 2.

FIG. 8A shows a film containing nanomaterials at varying concentrations in Embodiment 2 of the present disclosure.

FIG. 8B is a sampling schematic diagram.

FIG. 8C is an application test diagram of PM_{2.5}-B(a)P.

FIG. 8D shows the disclosure test diagram of B(a)P in sausage.

### DETAILED DESCRIPTION OF THE EMBODIMENTS

The embodiments of the present disclosure are described below through specific examples, and those skilled in the art can easily understand other advantages and effects of the present disclosure from the contents disclosed in this specification. The disclosure can also be implemented or applied by other different specific embodiments, and various details in this specification can be modified or changed based on different viewpoints and applications without departing from the spirit of the disclosure.

It should be noted that the experimental methods in the following examples are all conventional methods unless otherwise specified. The materials and reagents used in the following examples can be obtained from commercial sources unless otherwise specified. The process equipment or devices not specified in the following examples are all conventional in this field.

The experiments used for testing in the disclosure are as follows:

1) Sausage production: removing fat and tendons from fresh pork leg, respectively crushing lean meat and fat, and mixing lean meat and fat according to the ratio of (2:8, w/w), marinating the minced meat with 2% salt, and putting the marinated meat into sausage casings; suspending sausages wrapped with composite starch film in a smoking furnace, and using apple wood for smoking at 90° C. for 4 h; for untreated group, directly exposing sausages to the smoking furnace, and setting three replicates in each group.

2) Determination of B(a)P: adding a sausage sample (5 g) into 10 mL n-hexane, performing ultrasonic treatment for 30 min (repeated twice), and putting the supernatant of the two extracts into a 50 mL centrifuge tube; then activating respectively the B(a)P extraction column with 5 mL dichloromethane and 5 mL n-hexane; pouring the extracted supernatant into the extraction column for sample injection, then washing with 5 mL n-hexane and collecting with 5 mL dichloromethane; carrying out nitrogen blowing on the collected eluent, and adding 1 mL acetonitrile for redissolution, and then detecting by High-Performance Liquid Chromatography (HPLC)-Fluorescence Detector (FLD). The smoked composite starch film (about 3 g) is extracted with n-hexane after cutting, and the treatment process is the same as above.

HPLC-FID conditions: a) chromatographic column: C18, column length 250 mm, inner diameter 4.6 mm, particle size 5 μm; b) mobile phase: acetonitrile+water=88+12; c) flow rate: 1.0 mL/min; d) fluorescence detector: excitation wavelength 384 nm, emission wavelength 406 nm; c) column temperature: 35° C. and f) sample volume: 20 μL.

### 3) Photocatalytic Experiment

Taking B(a)P with strong stability as the research object, the degradation reaction is carried out in a photocatalytic reactor built in the laboratory. 0.05 g of TiO₂-CQDs nanoflower photocatalyst is added to the B(a)P standard sample (20 mL) with a concentration of 20 μg/L. In the process of photodegradation experiment, ultraviolet light is placed in the center of the reactor. The ultraviolet lamp is turned on at 25° C., and samples are taken every 5 min for 30 min. The level of B(a)P is detected by HPLC-FLD.

$$Degradation efficiency = Ct / C 0 \times 100 \%$$

C0 and Ct are the concentrations (μg/L) of B(a)P at the beginning of the reaction and at t reaction time, respectively.

### 4) Particulate Matter Collection

Photocatalytic degradation of PM_{2.5}-B(a)P during wood combustion is studied on a laboratory platform. Wood is burned in the container, and the generated smoke is connected to the inhalable particulate matter discharge device and the ultraviolet catalytic oxidation device in turn. Inhalable particulate matter is collected by JCH-120F inhalable particulate matter sampler (Qingdao, China) and Ahlstrom-Munksjo quartz fiber fiber filter paper (Finland), and inhalable particulate matter with diameter less than 2.5 μm is collected by PM_{2.5} splitter. The sampling space is about 10 m×5 m, and the sampling time is 6 h at the flow rate of 100 L/min under the conditions of 25° C. and relative humidity of 40%. After sampling, the quartz fiber filter paper is wrapped with aluminum foil and is storef at −20° C. The calculation formula of PM_{2.5}-B(a)P is as follows:

$$ρ t = \frac{ρ t \times V \times DF}{Va}$$

ρ: environmental PM_{2.5}-B(a)P, ng/m³.

ρt: measured concentration of B(a)P, ng/mL.

V: concentration volume of the sample, mL.

Va: total volume, m³.

DF: dilution factor.

### Embodiment 1

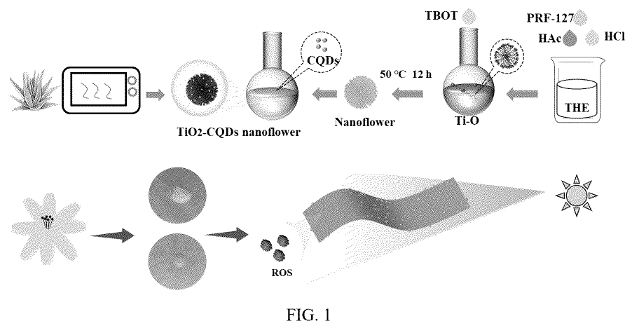

Referring to FIG. 1, a synthesis method of TiO₂-CQDs nanoflower photocatalyst, specifically:

### 1) Preparation of A/R-TiO₂ Nanoflowers

Placing 60 mL of tetrahydrofuran (THF) in a beaker, and then adding 4 g Pluronic(R)F-127, 6.4 mL acetic acid (>99%) and 8 mL HCl (38%) in turn; dropwise adding 4 mL tetrabutyl titanate with continuous stirring (300 r/min), and then aging at 50° C. for 6-8 h; dissolving the aged colloidal substance (4 g) in 20 mL ethanol, then adding 10 mL glycerol for a reflux of 12 h at 110° C.; drying the precipitate after ethanol cleaning at 80° C., and then sintering at 550° C. to obtain A/R-TiO₂ nanoflowers.

Dropwise adding 4 mL tetrabutyl titanate with continuous stirring (300 r/min), and then aging at 50° C. for 6-8 h; dissolving the obtained colloidal substance in ethanol, then adding 10 mL glycerol for a reflux of 12 h at 110° C.; drying the precipitate after cleaning at 80° C., and then sintering at 550° C. to obtain A/R-TiO₂ nanoflowers.

2) Synthesis of CQDs from Sloe Extract

Putting different quality aloe extracts (purchased from Shanghai Macklin Biochemical Technology Co., Ltd.) into a volumetric flask, and adding 20 mL deionized water; putting aloe extracts with different qualities into the volumetric flask, and then adding 20 mL of deionized water; fully stirring the solution, then irradiating with 600 W microwave for 20 min, cooling and centrifuging at a speed of 10000 g/min; after centrifugation, drying at 80° C. to obtain brown CQDs.

### 3) Synthesis of TiO₂-CQDs Nanoflower Photocatalyst

Dispersing 1 g A/R-TiO₂ nanoflowers synthesized by hydrothermal method in ethanol, dispersing the CQDs in water, and then the CQDs solution dropwise adding into the A/R-TiO₂ nanoflower solution at a stirring speed of 300 r/min for 2 h; then centrifuging the product, washing the product with ethanol three times and drying the product in vacuum at 100° C.; then sintering the product at 550° C. to obtain TiO₂-CQDs nanoflower photocatalyst. TiO₂-CQDs nanoflower photocatalysts prepared from 100 mg, 250 mg and 500 mg aloe extract are named as TiO₂-CQDs-1, TiO₂-CQDs-2 and TiO₂-CQDs-3 respectively.

### Characterizations of TiO₂-CQDs Nanoflower Photocatalyst

### 1) Photocatalyst Characterization

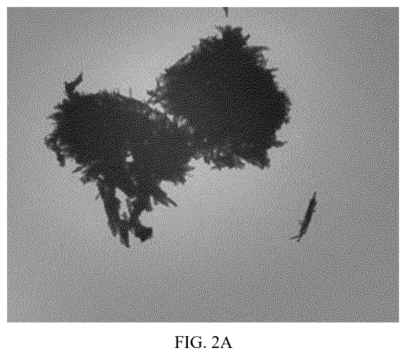

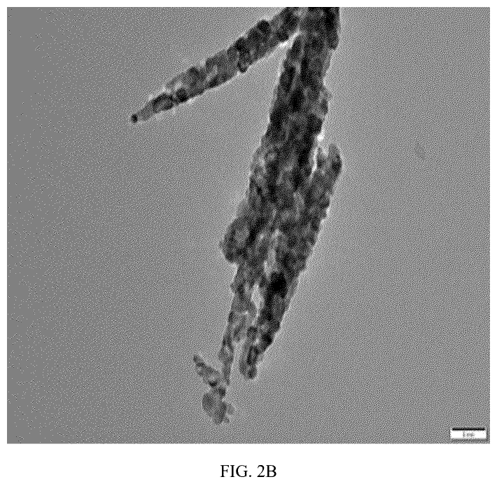

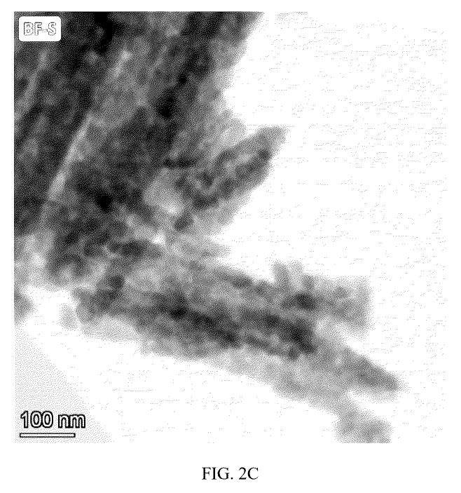

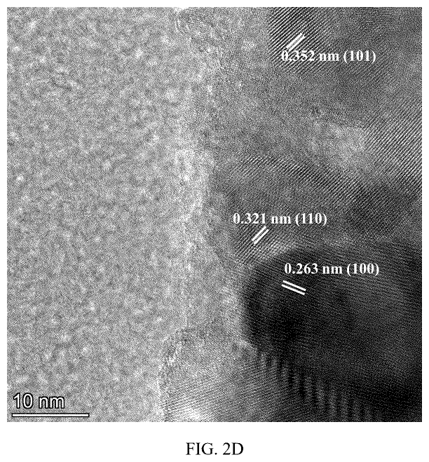

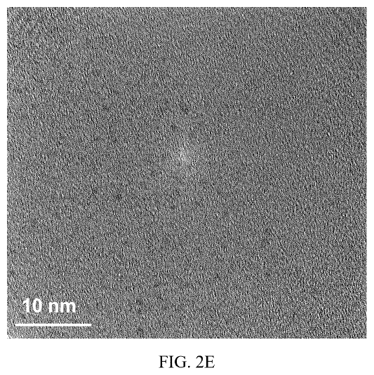

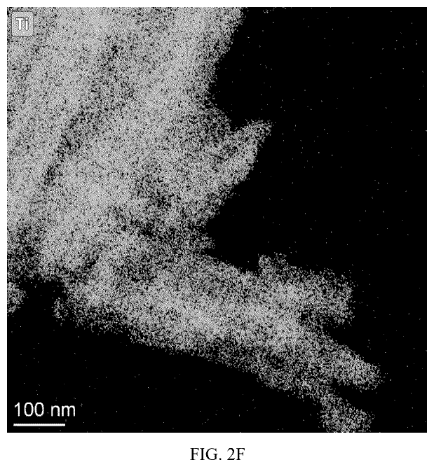

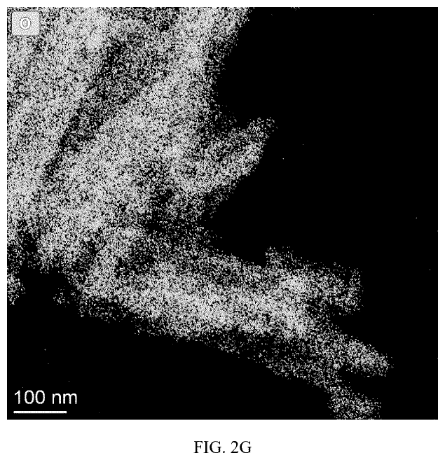

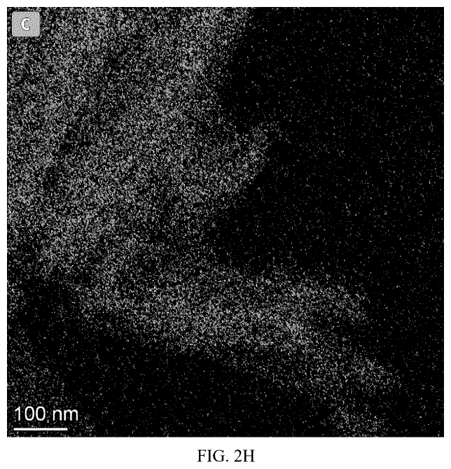

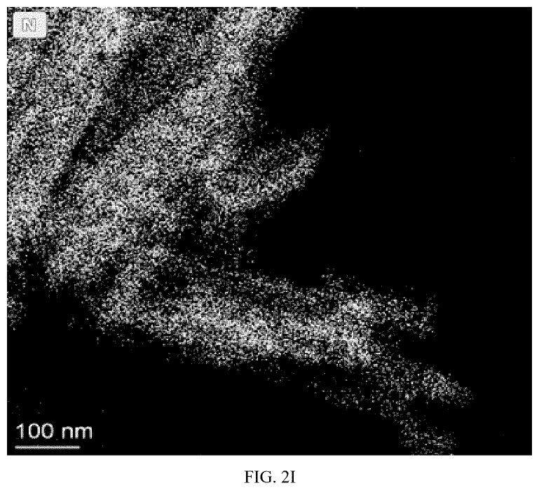

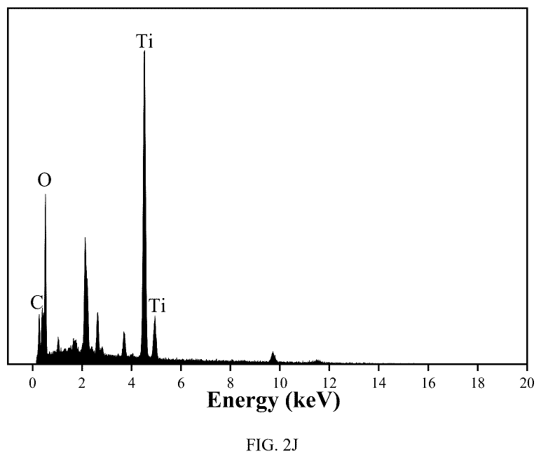

EFTEM images show the internal structure and crystal lattice of TiO₂-CQDs-2 nanoflower photocatalyst. As shown in FIG. 2A, FIG. 2B and FIG. 2C, the prepared TiO₂ has obvious nanoflower structure, which indicates that the crystal growth of TiO₂ occurs under strong acid conditions, rather than the accumulation of small nano-sheets. The edge of the nanoflower increase the contact area of the photocatalyst. The lattice fringe spacing is an important index in substances that reflect the morphological characteristics of catalytic materials. The lattice fringes of each photocatalytic material are clearly displayed (FIG. 2D), and a lattice fringe spacing of 0.352 nm is observed in the TiO₂-CQDs, and is in correspondence with a plane (101) of anatase-TiO₂. a characteristic lattice fringe spacing of 0.321 nm is observed in the TiO₂-CQDs, aligning with a plane (110) of rutile-TiO₂, while a spacing of 0.263 nm is attributed to a plane (100) of the CQDs. In addition, CQDs presents CQD morphology with different particle sizes (FIG. 2E), and the particle size is about 1.5-2.5 nm. The close contact between CQDs and TiO₂ nanoflowers promoted the charge transfer during the photocatalytic reaction. As shown in FIG. 2F, FIG. 2G, FIG. 2H, FIG. 2I and FIG. 2J, Ti, O, C and N are completely detected in the TiO₂-CQDs nanocomposite, which further proved the successful preparation and structural characteristics of the TiO₂-CQDs photocatalyst.

### 2) Structural Characterization

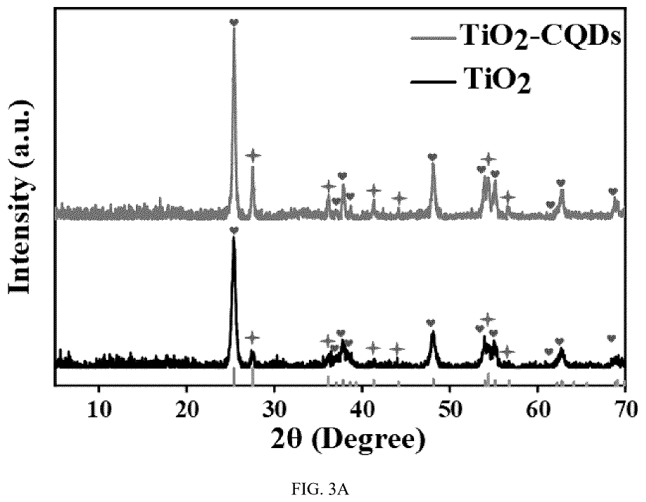

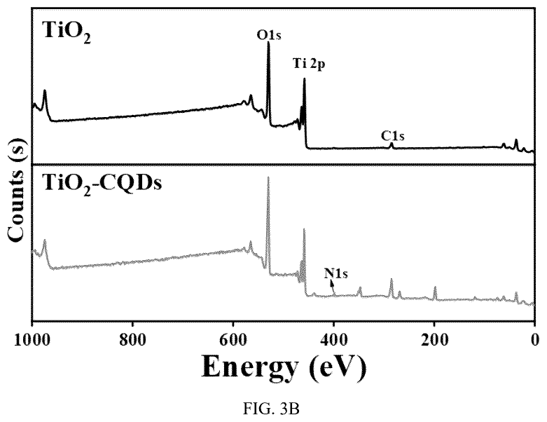

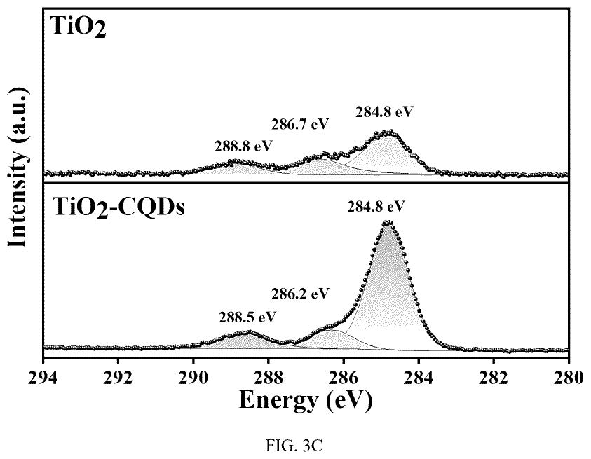

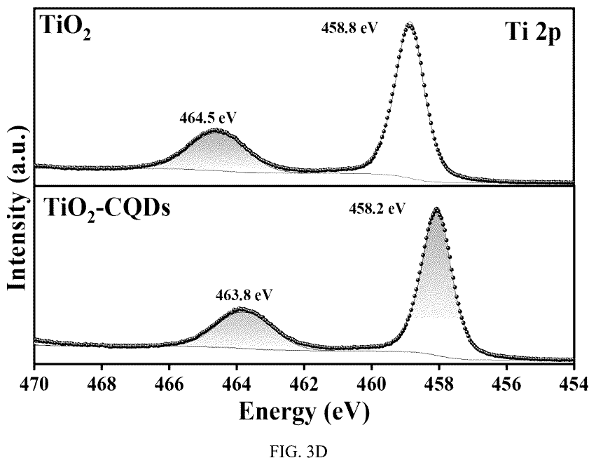

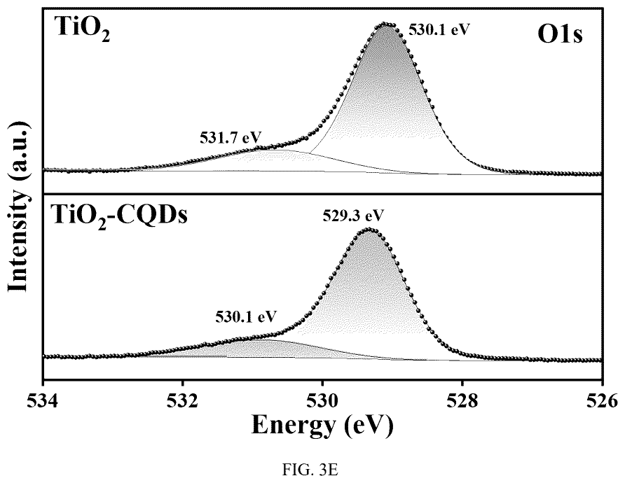

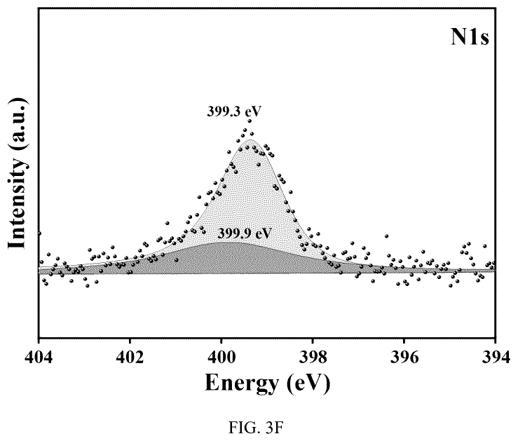

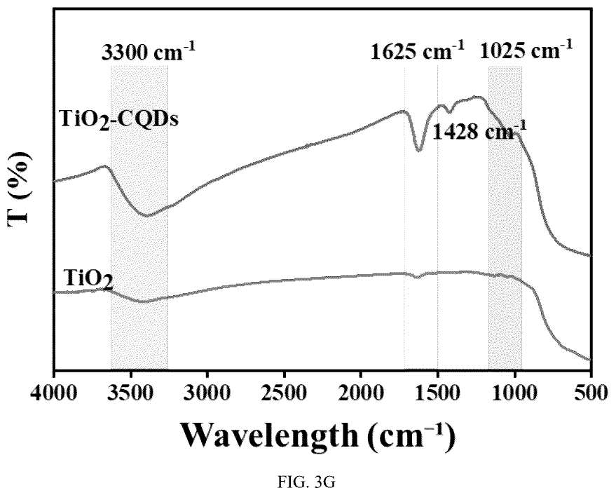

The crystal structure of the prepared materials is determined by XRD. As shown in FIG. 3A, TiO₂-CQDs nanoflower photocatalyst has good crystallinity. The peak value of TiO₂-CQDs can be obtained according to PDF No. 99-0008 and PDF No. 99-0090. Obviously, the typical peaks at 25.3°, 37.7°, 48.0°, 53.8°, 55.0° and 62.6° are different from those at planes (101), (004), (200), (105), (201) and (200) of anatase TiO₂, respectively. The typical peaks at 27.4°, 36.1°, 41.2°, 44.1° and 56.6° are consistent with those at planes (110), (101), (111), (210), (211) and (220) of rutile TiO₂, respectively. XRD analysis shows that TiO₂ is a composite of anatase and rutile, and no other impurities are detected, which indicates that TiO₂-CQDs has high purity without interference from other substances. TiO₂-CQDs has no obvious CQDs characteristic peak, which is attributed to the very small and disordered crystal structure TiO₂-CQDs, resulting in its XRD pattern showing extensive background scattering and lacking clear characteristic peak.

XPS is used to analyze the elemental composition and chemical state of the surface of photocatalyst samples, and FIG. 3B shows the detailed information of Ti2p, O1s, N1s and C1s of TiO₂-CQDs. As shown in FIG. 2C, the fitting peaks at 288.5 eV, 286.4 eV, 284.8 eV in C1s orbit of TiO₂-CQDs represent C═O, C—N and C—C bonds respectively. The recombination of CQDs leads to the obvious vibration of C Is orbital peak of TiO₂-CQDs, especially the C—C bond. The two characteristic peaks at 464.5 CV and 458.9 eV in FIG. 3D are Ti³⁺ 2p1/2 and Ti³⁺ 2p3/2, respectively, indicating that Ti³⁺ is formed in the composite TiO₂-CQDs. Previous studies have shown that oxygen vacancies in photocatalytic materials will lead to the generation of unpaired electrons or Ti³⁺ centers, which will induce the charge transfer rate of TiO₂ electrons or holes. The existence of defects in rutile TiO₂ should contribute to the formation of Ti³⁺ during the photocatalytic reaction. Surface defects (i.e. hydroxyl groups) make the valence band top of rutile TiO₂ move up, thus enhancing the photocatalytic activity. Rutile TiO₂ is confirmed by XRD results. The O1s spectral fitting peak of TiO₂-CQDs has two deconvolution peaks at 531.7e V and 530.1 eV, corresponding to lattice oxygen atom and Ti—O respectively. Therefore, compared with TiO₂, TiO₂-CQDs produces more oxygen vacancies, and the existence of oxygen vacancies stimulates the generation of active oxygen (FIG. 3E). The obvious fitting peaks of N1s spectrum (FIG. 3F) at 399.3 eV and 399.9 eV represent nitride and metal oxynitride, respectively. Nitrogen doping effectively induces charge delocalization, reduces work function, changes the mechanism of electron transport and catalytic reaction, and effectively enhances the catalytic activity and selectivity of CQDs. With the addition of CQDs, the binding energy of C, Ti and O is shifted to the direction of low binding energy, proving that the interaction between CQDs and TiO₂ is close.

The FTIR spectrum of the photocatalyst is shown in FIG. 3G, and the tensile vibration of 3300 cm⁻¹ represents the tensile vibration of O—H. There are O—H characteristic vibration peaks in TiO₂ and TiO₂-CQDs, and the vibration of TiO₂-CQDs is more obvious. The vibration with the characteristic peak of TiO₂-CQDs at 1611 cm⁻¹ is attributed to the stretching vibration of N—H. At the same time, the stretching peak at 1428 cm⁻¹ represents the vibration of C—C, and 1025 cm⁻¹ is due to the stretching vibration of C—O—C. Previous studies have shown that when these oxygen-containing groups absorb energy, the electrons in their molecules will be excited to a high-energy state, forming an excited state. The excited state makes molecules have different chemical properties and reactivity.

### 3) Optical Characteristics

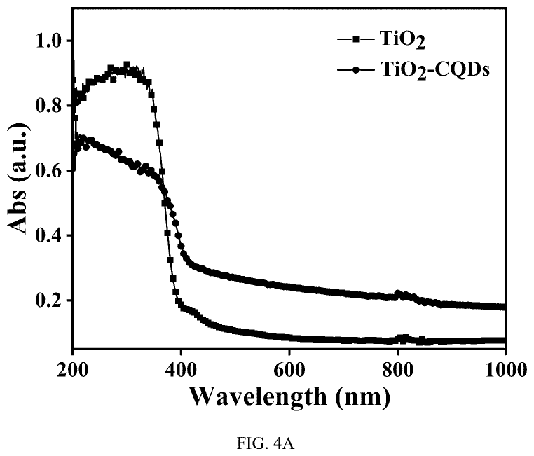

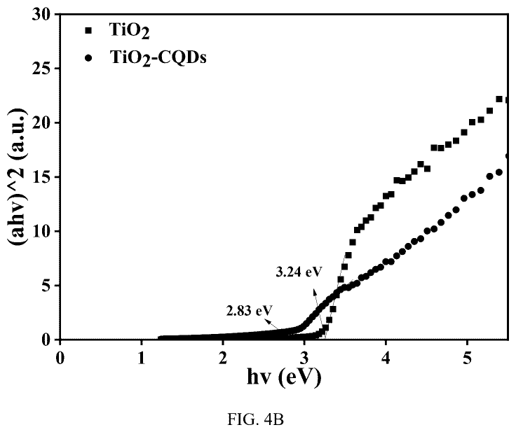

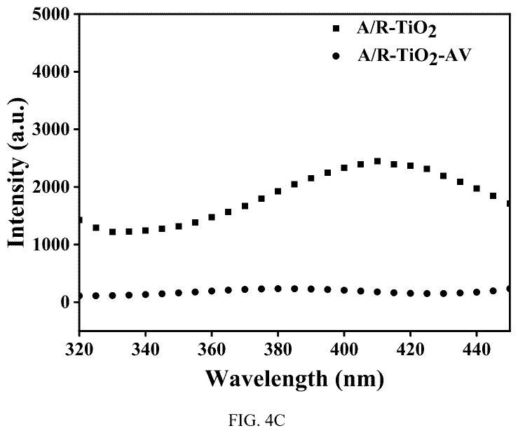

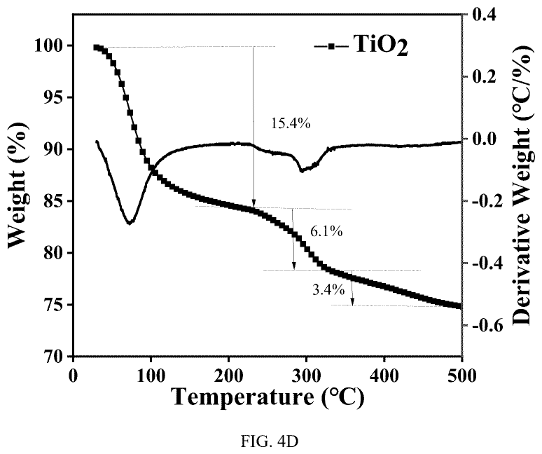

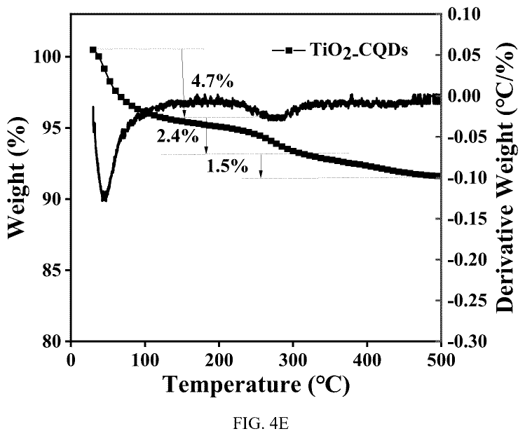

Referring to FIG. 4A, FIG. 4B and FIG. 4C, FIG. 4A shows that TiO₂ shows a wide absorption band under the ultraviolet light with the wavelength of 200-400 nm, and the absorption of TiO₂-CQDs shifts to the high frequency region, indicating that the recombination of CQDs enhances the ultraviolet absorption and makes a redshift of the TiO₂ absorption peak. Further, Eg is estimated according to the intercept of the curve tangent in the photon energy relationship diagram. Eg refers to the minimum energy required for electrons in photocatalyst materials to transition from valence band to conduction band, and is an important parameter for evaluating the light absorption and photocatalytic activity of photocatalyst. The results show that the an energy band gap of TiO₂ decreases from 3.24 eV to 2.91 eV with the addition of CQDs (FIG. 4B), which may be caused by the introduction of a new energy state at the molecular orbital interface of TiO₂-CQDs. Photoluminescence (PL) refers to the light phenomenon that a substance emits after being excited by light. PL spectrum vibration indicates the recombination ability of photo-generated electron-hole pairs. As shown in FIG. 4C, TiO₂ shows a broad luminescence peak around 360-440 nm, with a central peak around 410 nm. This shows that the photo-generated carriers recombine seriously and the photocatalytic oxidation reaction is not easy to occur. However, the luminescence intensity of TiO₂-CQDs is greatly reduced, and the doping of CQDs makes the photogenerated electrons of TiO₂ migrate in time, and the recombination of electron pairs is inhibited in time. Therefore, it can be inferred that TiO₂ composite CQDs significantly promoted the charge separation process.

FIG. 4D and FIG. 4E show the thermogravimetric curves (TGA) of TiO₂ and TiO₂-CQDs. Both of the two photocatalysts show different degrees of mass change at 25-500° C., which is related to the evaporation of water on the surface of the sample. The mass loss at the initial stage of 25-200° C. is attributed to the volatilization of adsorbed water, and the mass loss of TiO₂ and TiO₂-CQDs is 15.4% and 4.7% respectively. Further, the second mass loss occurred at 200-300° C., and the loss at this stage is small, which may be mainly due to the decomposition of oxygen-containing groups in TiO₂. The loss of TiO₂-CQDs at 300-500° C. is higher than that of TiO₂, and TiO₂-CQDs shows obvious stability at 300-500° C. The loss in the third stage may be related to the dehydration of —OH group. Generally speaking, the decomposition temperature of TiO₂-CQDs composite is higher, which indicates that there are chemical bond changes between the composite of TiO₂-CQDs and the original metal material, which enhances the intermolecular force and the high temperature resistance of the composite.

### 4) Photocatalytic Activity

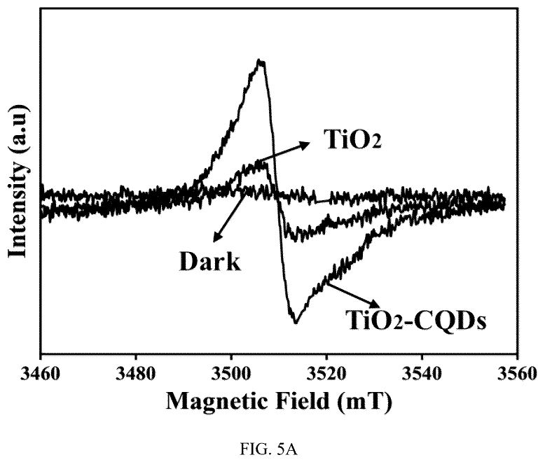

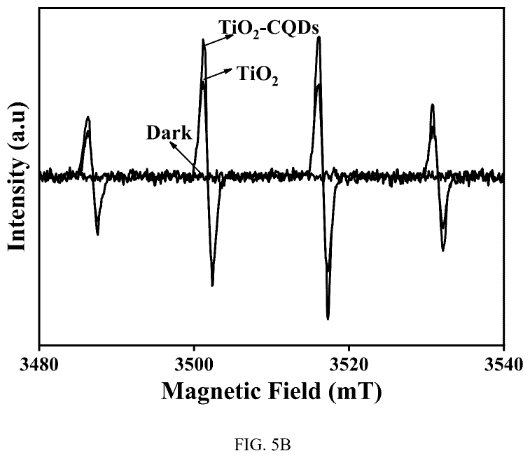

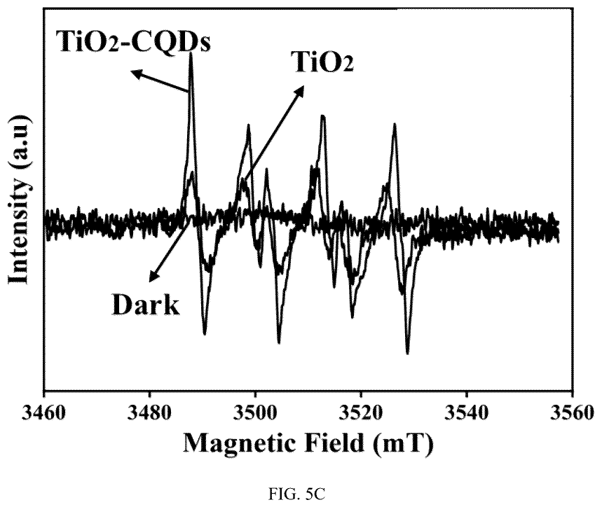

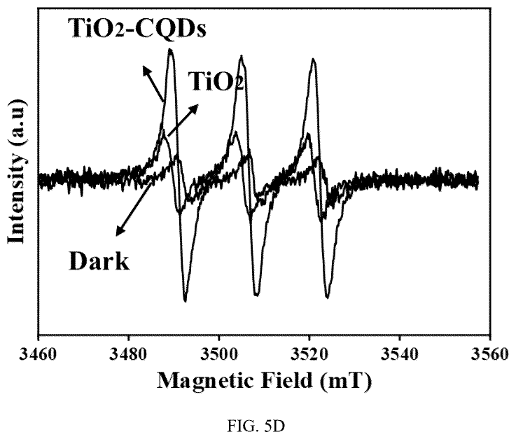

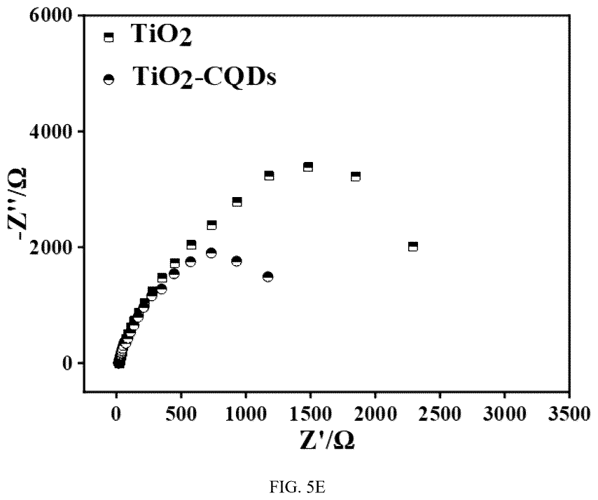

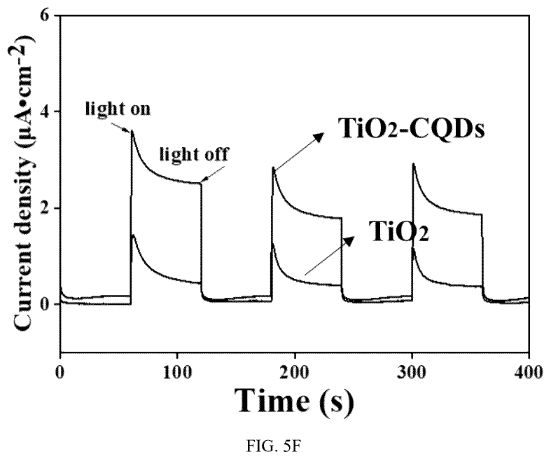

Referring to FIGS. 5A-5D, electron spin resonance (ESR) technology is applied to test the active substances produced by TiO₂-CQDs under ultraviolet irradiation. Oxygen vacancies can introduce local electronic state oxygen vacancies into the band gap of materials and also play a role in the catalytic process. As shown in FIG. 5A, there is no obvious signal of oxygen vacancy under dark conditions, and TiO₂-CQDs shows obvious oxygen vacancy after ultraviolet irradiation. This is due to the fact that dopants occupy the position of oxygen atoms in the crystal lattice, thus increasing the number of oxygen vacancies and improving the electron transport ability and light absorption characteristics. The results of FIG. 5B and FIG. 5C show that obvious DMPO-·OH and DMPO-·O₂⁻ adducts are observed in both TiO₂ and TiO₂-CQDs after illumination, indicating that ·OH and ·O₂⁻ free radicals exist in the photocatalytic system. Compared with pure TiO₂, the ·OH and ·O₂⁻ free radical signals of CQDs composite samples are stronger. CQDs can absorb light energy and excite electrons, making them jump to conduction band, thus forming active electrons and participating in oxygen reduction reaction. These active electrons can combine with oxygen molecules to generate reactive oxygen species such as ·OH and ·O₂⁻. The signal intensity of TEMPO-h⁺ is detected in FIG. 5D. The signal intensity is obvious under dark conditions, and the signal is obviously weakened after ultraviolet irradiation.

Impedance is a parameter that describes the resistance and admittance of a circuit to AC electrical signals. The radius of the electrode arc of TiO₂-CQDs is smaller than that of TiO₂, which indicates that the AV-doped photocatalyst has lower interfacial resistance and inhibits the recombination of carriers (FIG. 5E). The measurement of photocurrent can be used to evaluate the current intensity of photocatalytic materials. The results of FIG. 5F show that the photocurrent intensity of TiO₂-CQDs is the strongest, and the oxygen-rich structure enhances the light absorption. The doping of CQDs introduces additional free electrons or holes into semiconductor materials, increases the carrier concentration and promotes the separation efficiency of electrons and holes.

### 5) Degradation of B(a)P

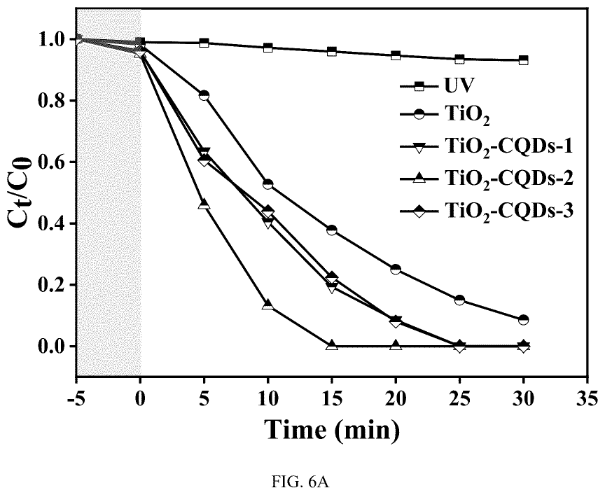

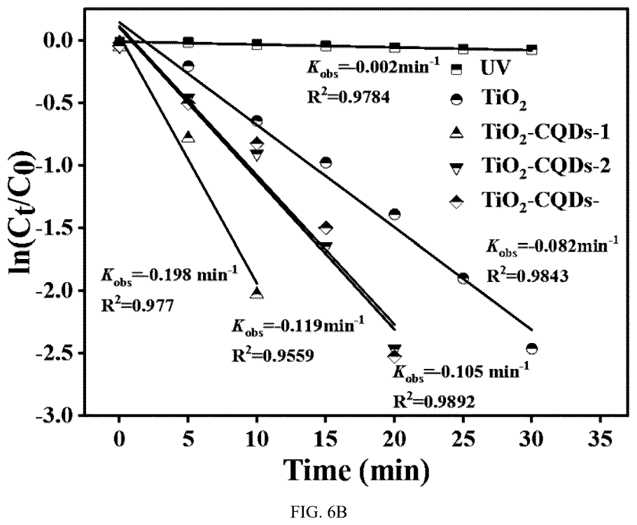

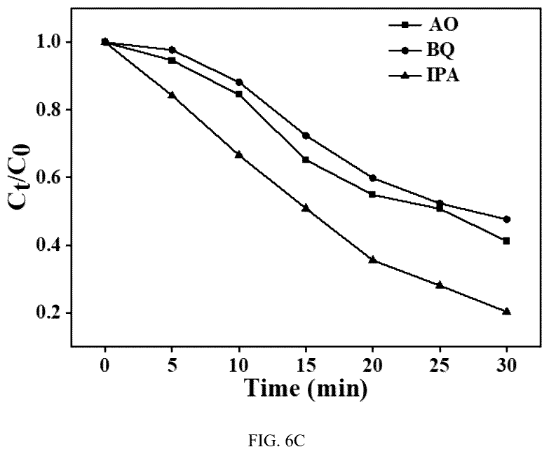

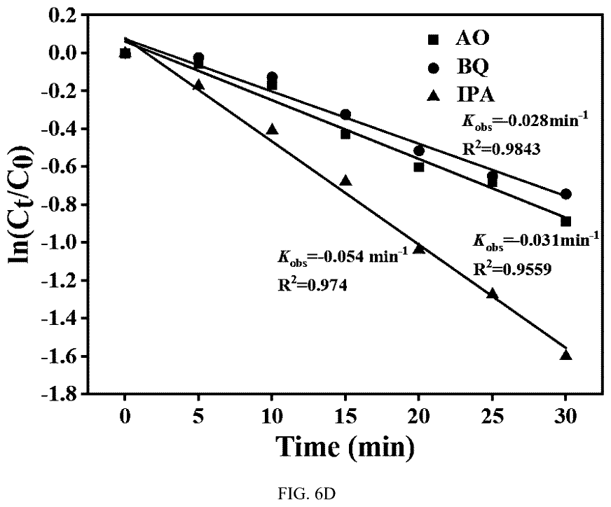

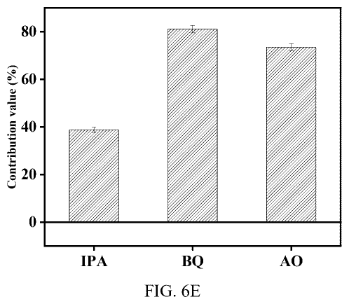

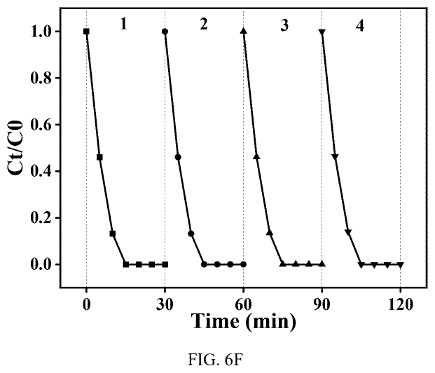

In order to study the degradation of B(a)P by CQDs, the degradation of B(a)P standard solution by different catalysts is studied under ultraviolet irradiation. As shown in FIG. 6A, the effect of single ultraviolet irradiation on B(a)P is negligible. Different catalysts were equilibrated in the dark for 20 min. Compared with TiO₂, TiO₂-CQDs nanoflowers showed more obvious photodegradation ability, and B(a)P irradiated for 30 min and 20 μg/L is completely degraded. In the UV-bonded TiO₂-CQDs-2 nanoflower system, the same concentration of B(a)P can be rapidly degraded under light conditions, and it can be completely degraded within 15 min. This is mainly because the three-dimensional structure of TiO₂-CQDs nanoflowers provides a highly reactive surface.

The degradation rates of different catalysts were calculated by first-order kinetic equation. The results of FIG. 6B show that TiO₂-CQDs-2 shows the most significant photocatalytic rate (k=−0.198 min⁻¹), and the degradation rates of TiO₂-CQDs-1 and TiO₂-CQDs-3 are −0.119 min⁻¹ and −0.105 min⁻¹. The photocatalytic efficiency of single ultraviolet irradiation is the lowest (K=−0.002 min⁻¹). The experimental results show that the photocatalytic effect of photocatalyst on B(a)P is closely related to the doping density of CQDs. The photocatalyst activity is determined by the active site of photocatalyst and ultraviolet light penetration, and the reaction site is insufficient when the concentration of photocatalyst is low. Of course, the loading of high dose CQDs may produce shielding effect and light reflection to weaken the light absorption inside the reaction medium, so too low or too high catalyst dose will reduce the catalytic activity of photocatalyst.

The species and concentration of active species produced by TiO₂-CQDs play an important role in the photocatalytic degradation of B(a)P. Therefore, in order to further explore and analyze the mechanism of photocatalytic degradation of B(a)P by TiO₂-CQDs, p-benzoquinone (BQ), isopropanol (IPA) and ammonium oxalate (AO) are selected as quenchers to capture ·O₂⁻, ·OH and h⁺ respectively. As shown in FIG. 6C and FIG. 6D, the rate of degradation of B(a)P by TiO₂-CQDs decreased obviously after adding the trapping agent, especially when BQ is used as the trapping agent. Further, through (1-3), the contribution ability of different active free radicals to the degradation of B(a)P is obtained. FIG. 6E shows that the contribution ability of ·O₂⁻, ·OH and h+ is 86.21%, 73.40% and 83.73% respectively. FIG. 6F shows that TiO₂-CQDs still has stable recycling performance after four times of recycling.

$$R \cdot OH = \frac{{K}_{•OH}}{{K}_{BaP}} \approx 1 - \frac{{K}_{IPA}}{{K}_{BaP}} \qquad ( 1 )$$

$$R \cdot O 2 = \frac{{K}_{•O 2}}{{K}_{BaP}} \approx 1 - \frac{{K}_{BQ}}{{K}_{BaP}} \qquad ( 2 )$$

$$Rh += \frac{{K}_{h +}}{{K}_{BaP}} \approx 1 - \frac{{K}_{AO}}{{K}_{BaP}} \qquad ( 3 )$$

R_{·OH}: contribution rate (%); K_{·OH}: the reaction rate after adding ·OH scavenger (min⁻¹); K_{B(a)P}: the degradation reaction rate of K_{B(a)P}: B(a)P(min⁻¹).

### Embodiment 2

### Preparation of Photocatalytic Thin Films

Adding 3-5% (w/v) sodium alginate (SA) into 100 mL of ultra-pure water and mixing thoroughly for 10-30 min on a magnetic stirrer at 300-800 rpm, adding 10-20% (w/v) glutaraldehyde as plasticizer, fully stirring to prepare SA solution, adding TiO₂-CQDs in the SA solution and continuously stirring for 1 h; then, removing the bubbles in the SA solution by ultrasonic wave for 30 min; finally, pouring the SA solution into a Teflon plate and drying at 50° C. for 8 h. The films with different mass of TiO₂-CQDs (0.5%, 1% and 2%, w/w) are named as 0.5% TCF, 1% TCF and 2% TCF respectively.

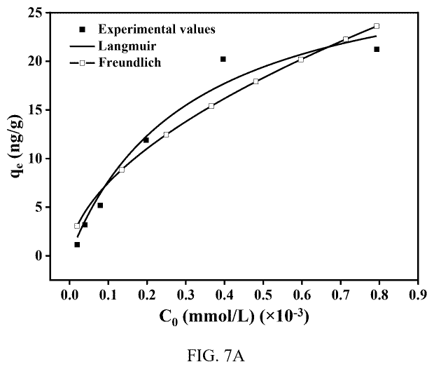

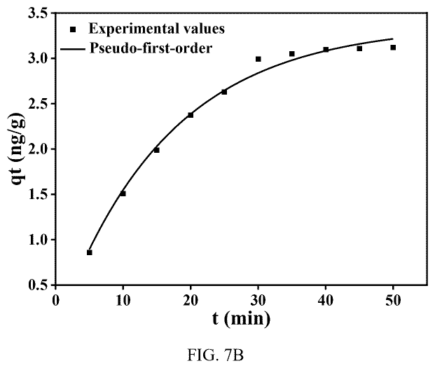

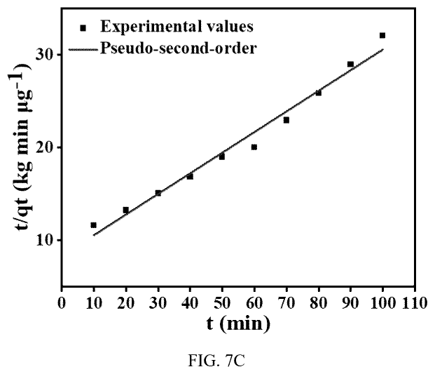

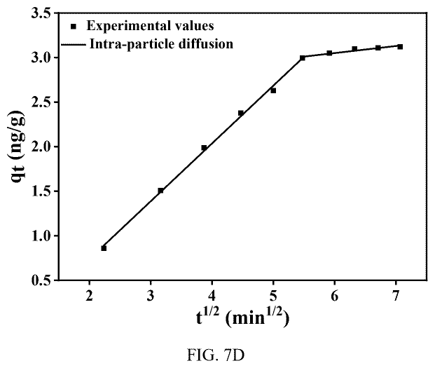

Characterization of film adsorption kinetics: The Langmuir adsorption model examines the formation of a unilayer adsorbate on the adsorbent's surface, typically employed to characterize the adsorption process at saturation. The Freundlich adsorption model, characterized as a multi-layer adsorption model, the adsorptive molecules are arranged in a multi-layered configuration upon the adsorbent surface. The presence of interactive forces among the adsorptive molecules is well-suited for characterizing non-ideal behaviors observed within the adsorption process. Langmuir and Freundlich adsorption models show the potential adsorption mechanism of TiO₂-CQDs photocatalytic thin film for B(a)P. As shown in FIGS. 7A-7D and Table 1, TiO₂-CQDs is closer to the Langmuir model, indicating that B(a)P is adsorbed on TiO₂-CQDs film in the form of monolayer (FIG. 7A). In the Freundlich adsorption model, the value of 1/n is greater than 1, signifying that B(a)P molecules are capable of establishing robust chemical adsorption bonds with the TiO₂-CQDs membrane. The relationship between the adsorption capacity of TiO₂-CQDs membrane for B(a)P and the contact time of the adsorbent is investigated, and the pseudo-first-order, pseudo-second-order and intra-particle diffusion models are used for fitting (FIG. 7B and FIG. 7C). The findings demonstrate that the adsorption rate of TiO₂-CQDs thin films experiences an initial upsurge, attributable to the abundance of adsorption sites. The pseudo first-order model (R²⁼0.991) and pseudo second-order model (R²⁼0.981) fit the adsorption data of TiO₂-CQDs thin films well. The results of intra-particle diffusion model indicate that the adsorption process is multi-staged, K₁>K₂>K₃, demonstrating that film diffusion is the primary driving force for adsorption (FIG. 7D).

TABLE 1
Adsorption isotherm and kinetic simulation of TCF film

| | | R² | q | k |
|---|---|---|---|---|
| TiO₂-CQDs | Langmuir | 0.971 | 31.38 | 0.309 |
| | | R² | k | n |
| | Freundlich | 0.918 | 26.84 | 0.553 |
| | | R² | a | b |
| | Pseud-first | 0.991 | 3.37 | 0.061 |
| | order | | | |
| | Pseud-second | 0.981 | 8.34 | 0.222 |
| | order | | | |
| | Inter-particle | R₁² = 0.999 | C₁ = −0.68 | K₁ = 0.488 |
| | | R₂² = 0.997 | C₂ = −0.37 | K₂ = 0.432 |
| | | R₃² = 0.954 | C₂ = 2.57 | K₂ = 0.056 |

### Application of TCF Film

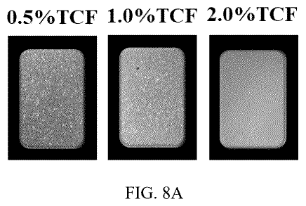

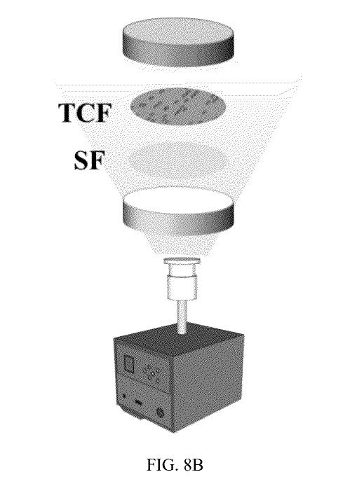

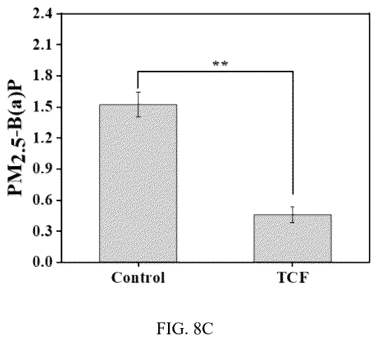

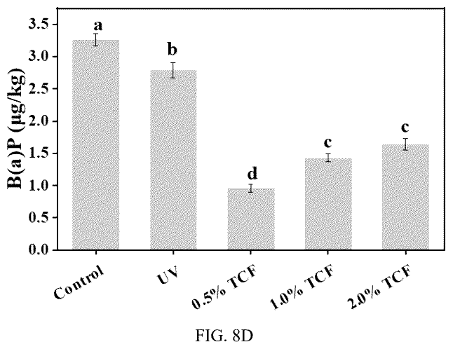

Evaluation of adsorption and photodegradation ability of TCF film for PM_{2.5}-B(a)P in smog environment. FIG. 8A and FIG. 8B show the situation of sampling film (SF) and SF+TCF film during the collection of particulate matter. The results indicate that during the 10-hour collection process, the presence of TCF leads to a 69.8% reduction in PM_{2.5}-B(a)P (FIG. 8C). This demonstrates that the TCF film is effective in mitigating the atmospheric emissions of PM_{2.5}-B(a)P in practical applications. Motivated by the remarkable adsorptive and photodegradative performance of TCF film against PM_{2.5} pollutants in smog, an assessment of the film's capacity to degrade B(a)P within smoked sausage is conducted. As shown in FIG. 8D, the B(a)P in the untreated sausage is 3.26 μg/kg, and the single ultraviolet ray can reduce the B(a)P in the sausage, but the inhibition ability is much lower than that in other groups. The combination of 0.5% TCF, 1% TCF and 2% TCF with ultraviolet rays can reduce B(a)P in sausages by 70.9%, 56.1% and 49.7% respectively. Excessive photocatalyst can reduce the ability of light to penetrate the material by reducing the transmittance of the gel and increasing the absorption and scattering of light.

The embodiments described above serve to illustrate the principle and efficacy of the present disclosure, but they are not intended to be limiting. Skilled artisans in the field can easily make modifications or alterations to these embodiments without deviating from the spirit and scope of the present disclosure. Consequently, any adaptations or modifications that are deemed equivalent by individuals with ordinary skill in the art, and that do not stray from the inventive concepts and principles set forth in this disclosure, should be considered within the ambit of the claims of the present disclosure.

What is claimed is:

1. A TiO₂-CQDs nanoflower photocatalyst, comprising TiO₂ and CQDs doped with TiO₂. the CQDs is derived from aloe extract.

2. The photocatalyst according to claim 1, wherein a crystal structure of TiO₂ is selected from one of anatase, rutile and brookite, or a mixed phase of any two crystal forms or a mixed phase of three crystal forms;
and/or, in terms of a total mass of the TiO₂-CQDs nanoflower photocatalyst, a mass content of CQDs is 10-50 wt %;
and/or, in the TiO₂-CQDs nanoflower photocatalyst, a particle size of CQDs is 1.5-2.5 nm;
and/or, an ultraviolet absorption band of the TiO₂-CQDs nanoflower photocatalyst is 200-420 nm;
and/or, an energy band gap of the TiO₂-CQDs nanoflower photocatalyst is 2.8-3.1 eV;
and/or, a degradation rate of the TiO₂-CQDs nanoflower photocatalyst is 0.1-0.2 min⁻¹;
and/or, typical peak values of the TiO₂-CQDs nanoflower photocatalyst are 25.3°, 37.7°, 48.0°, 53.8°, 55.0°, 62.6°, 27.4°, 36.1°, 41.2°, 44.1° and 56.6°.

3. A preparation method of the TiO₂-CQDs nanoflower photocatalyst, comprising following steps:
1) providing TiO₂ nanoflowers;
2) performing microwave reaction on the aqueous solution or aqueous suspension of the purchased aloe extract, and performing post-treatment to obtain CQDs; and
3) mixing the solution or suspension containing TiO₂ nanoflowers with the solution or suspension containing CQDs, stirring at 100-500 r/min for 1-5 h, and drying and sintering to obtain the TiO₂-CQDs nanoflower photocatalyst.

4. The preparation method of the TiO₂-CQDs nanoflower photocatalyst according to claim 3, comprising at least one of following technical features:
a) in the step 1), Pluronic(R)F-127, acetic acid and hydrogen chloride (HCl) are dissolved in tetrahydrofuran, tetrabutyl titanate is added under stirring, dissolved in alcohol solvent after aging, and glycerol is added, and after reflux reaction for 6-24 h, TiO₂ nanoflowers are obtained through cleaning, drying and sintering;
b) in the step 2), the conditions of microwave reaction are as follows: irradiating the aqueous solution or suspension of aloe for 10-60 min under the microwave condition of 400-800 W;
c) in the step 2), the post-treatment comprises centrifugation to obtain the CQDs precursor, followed by drying the CQDs precursor at a temperature between 70-90° C. to obtain the CQDs;
d) in the step 3), the drying temperature is 80-100° C.;
e) in the step 3), drying is carried out under vacuum condition;
f) in the step 3), the sintering temperature is 500-650° C.; and
g) in terms of the total mass of TiO₂-CQDs nanoflower photocatalyst, a mass content of CQDs is 10-50 wt %.

5. The preparation method of the TiO₂-CQDs nanoflower photocatalyst according to claim 4, wherein in the technical feature a),
a mass ratio of Pluronic (R) F-127, tetrahydrofuran, acetic acid, HCl and tetrabutyl titanate is 5-6:60-80:5-8:6-10:1-5;
a ratio of the aged colloidal substance mass, the alcohol solvent volume and the glycerol volume is 1-5:10-40:5-15.

6. A photocatalytic thin film, comprising the TiO₂-CQDs nanoflower photocatalyst according to claim 1 or the TiO₂-CQDs nanoflower photocatalyst prepared by the preparation method.

7. The photocatalytic thin film according to claim 6, wherein the content of TiO₂-CQDs nanoflower photocatalyst is 0.1-5 wt % in terms of solvent mass;
and/or, the photocatalytic thin film further includes a film material;
and/or the photocatalytic thin film further includes a plasticizer.

8. The photocatalytic thin film according to claim 7, wherein the film material is selected from sodium alginate or water-soluble polymer. and the plasticizer is glutaraldehyde;
in terms of a total mass of the photocatalytic thin film, the content of plasticizer is 10-30 wt %.

9. An application of the TiO₂-CQDs nanoflower photocatalyst according to claim 1, or the TiO₂-CQDs nanoflower photocatalyst prepared by the preparation method, or the photocatalytic thin film in controlling PAHs.

10. The application according to claim 9, wherein an application in controlling PAHs in smoked food and an application in controlling PAHs in smoked environment; and PAHs are B(a)P.
